(19) United States
(12) Patent Application Publication
(10) Pub. No.: US 2015/0298601 A1
(43) Pub. Date: Oct. 22, 2015

(54) Vehicle glazing

(71) Applicants: WEBASTO SE, Stockdorf (DE); BAYERISCHE MOTOREN WERKE AKTIENGESELLSCHAFT, 80809 Munchen (DE)

(72) Inventors: Guido BOTT, München (DE); Bernhard HARNISCHFEGER, Dachau (DE); Oliver KLEINERT, Fürstenfeldbruck (DE); Andreas LANG, Gröbenzell (DE); Walter SCHÄTZLER, Starnberg (DE); Stefan SCHMUCK, München (DE); Johann MINATTI, München (DE); Martin PINSKER, Bruckberg (DE)

(21) Appl. No.: 14/434,993

(22) PCT Filed: Oct. 15, 2013
(86) PCT No.: PCT/EP2013/071521

§ 371 Date: Apr. 10, 2015

(30) Foreign Application Priority Data
Oct. 17, 2012 (DE) 10 2012 109 900.6

(51) Int. Cl. B60Q 3/02; B32B 17/10

(52) U.S. Cl. CPC B60Q 3/0213; B32B 17/10541; B32B 17/10018; B32B 17/10146; B32B 17/10091; B32B 17/10137; B32B 2605/006

(57) ABSTRACT

A vehicle glazing having a pane, a light-conducting layer, a refractive layer, and a light source. The light conducting layer is configured to conduct light coupled at its end side and has decoupling means, via which a light exit of conducted light is caused at least on one of its main surfaces. The light-conducting layer is materially bonded to the pane. The refractive layer is arranged between the pane and the light-conducting layer, has a lower index of refraction than the light-conducting layer, and is simultaneously implemented as a lamination layer. The light source is arranged such that light is coupled in at least one end side of the light-conducting layer.

The invention relates to a vehicle glazing, which is suitable in particular for illuminating an interior of a motor vehicle.

An interior light for a means of transportation is known from document DE 10360729 B4, in which an interior light is integrated with a printed circuit board having light-emitting diodes and electronics in a composite glass pane.

One object to be achieved is to specify an improved concept for glazings, which is more flexible to handle and enables a simplified production sequence.

This object is achieved with the subject matter of the independent patent claim. Refinements and embodiments are the subject matter of the dependent claims.

The improved concept is based on the idea of providing individual components of a vehicle glazing with illumination function separately, and subsequently combining them to form a composite using conventional production methods. In this case, in particular a component which is responsible for the light emission is prepared separately and can then be combined with a conventional pane, which can also be used in vehicle glazings without illumination function. Accordingly, a light source is also provided separately and can be attached without additional steps to the arrangement, which also enables simple replaceability of the light source, for example, for maintenance purposes. By way of the improved concept, production costs and also storage costs of the individual components of the overall arrangement can be reduced.

In one embodiment of the improved concept, a vehicle glazing comprises a pane, which e.g. is formed from toughened glass, TG in short, a light-conducting layer, and a light source. The light-conducting layer is configured to conduct light coupled in at one of its end sides and has decoupling means, via which a light exit of conducted light is caused on at least one of its main surfaces. The light-conducting layer is materially bonded to the pane. The light source is arranged such that light is coupled in on at least one end side of the light-conducting layer. Furthermore, a refractive layer is arranged between the pane and the light-conducting layer, which has a lower index of refraction than the light-conducting layer. The refractive layer is simultaneously implemented as a lamination layer.

Planar emission of light, which is coupled laterally into the layer, is enabled by way of the light-conducting layer having the decoupling means. Due to the refractive layer, for example, light which is guided in the light-conducting layer does not reach the refractive layer, but rather is reflected back into the light-conducting layer. This causes, inter alia, a higher light yield and better light transport in the light-conducting layer. In addition, the refractive layer prevents light from being radiated through the pane, i.e. light from the vehicle interior reaching the outside, for example. The pane itself can be a conventional pane, which is not affected by the light guiding or light emission. A uniform optical impression can be achieved by the material bond. The production outlay is further reduced by the simultaneous embodiment of the refractive layer as the lamination layer.

In one embodiment, the material bond is formed by means of the lamination layer. For example, a polyvinyl butyral film, PVB film in short, is used for this purpose.

The surface fraction of the layer in which the decoupling means are provided can be varied from a small fraction up to a complete surface embodiment depending on the application.

The arrangement of the light source outside the composite of pane and light-conducting layer enables a complex lamination of an illumination unit into a composite glass pane to be omitted. In addition, the necessity is dispensed with of conducting required electrical energy for an illumination unit into the composite glass pane, since in a vehicle glazing according to the improved concept, light coupling is performed directly or via corresponding optical waveguides into the light-conducting layer.

Due to the special arrangement of the light source on the edge of the composite or the light-conducting layer, the light source, which is formed from LEDs, for example, is also subjected to less thermal stress than when it is laminated into the glass composite. In addition, the light source can be replaced easily, so that destruction of the composite between pane and light-conducting layer does not occur.

In various embodiments, a holding element can optionally be provided on the composite, which enables fastening on a vehicle body of the vehicle. Additionally or alternatively, an optional foam embedding of the edge region of the composite made of pane and light-conducting layer can be provided, which can also enclose the light source.

In some embodiments of the vehicle glazing, the light-conducting layer extends over the entire surface of the pane, so that the pane and the light-conducting layer form a glass composite or a composite glass, respectively. In a minor alteration thereof, it is also possible that the light-conducting layer extends over the entire surface of the pane with the exception of an edge region of the pane. A glass composite is also formed between pane and light-conducting layer in this embodiment.

In alternative embodiments, the light-conducting layer is attached in one or more partial regions of the surface of the pane. For example, the light-conducting layer has a strip shape or a ring shape and preferably extends on one or more edges of the pane. Decoupling of the light from the light-conducting layer is performed in this case, for example, both perpendicularly to the main surface of the pane or the light-conducting layer and also at the edge facing away from the light source or the end side of the light-conducting layer facing away from the light source. A desired light mood can thus be achieved in particular.

In various embodiments, the light-conducting layer is formed from glass, in particular a TG or a heat-strengthened glass, HSG in short.

Alternatively, the light-conducting layer is formed from a transparent plastic, in particular from polymethyl methacrylate, PMMA in short, or from a polycarbonate, PC in short. In particular in such an embodiment of the light-conducting layer from plastic, the decoupling means are formed, for example, by light-scattering particles embedded in plastic. The light-scattering particles are preferably not visible to the naked eye and cause a transparent impression of the plastic layer when the light source is turned off. The embedded particles cause scattering of the light at the particles, so that it is incident at an angle on the surface of the light-conducting layer, which enables an exit.

In other embodiments, both for embodiments of the light-conducting layer using glass and also using plastic, the decoupling means are formed by structuring of a surface of the light-conducting layer. The structuring is preferably embodied on the entire surface of the light-conducting layer. Alternatively, a desired illumination image can be generated by only regional structuring. Furthermore, the main surface of the light-conducting layer, which faces toward the pane, is preferably structured. The structuring of the surface can be performed, for example, by mechanical structuring, for example, impression of structures, by printing, in particular using a pad print, by etching, or by a blasting method, for example, sandblasting.

The light-conducting layer is implemented in various embodiments as a rigid plate, both in the embodiments using plastic and also using glass.

In one embodiment of the light-conducting layer using plastic, in particular using polycarbonate, the light-conducting layer can also be implemented as flexible, in particular as a flexible film. Such a flexible film may be fastened or laminated onto the pane with low production technology expenditure.

In the above-mentioned embodiments, a scratch-resistant coating can be applied in each case to the main surface of the light-conducting layer facing away from the pane.

The various described embodiments of the vehicle glazing enable modular applicability. In particular, the light-conducting layer can be combined with existing panes or roof glazings, without substantial design changes being necessary. The light-conducting layer can be constructed so that it has no or only a slight influence on force-transmitting elements of the vehicle glazing.

The invention will be explained in greater detail hereafter on multiple exemplary embodiments on the basis of the figures. Elements which have equivalent function or action bear the same reference signs in this case. Insofar as individual elements are described for one of the figures, the description thereof in the following figures is not necessarily repeated.

In the figures:

FIG. 1 shows a top view of a vehicle roof having a transparent roof part,

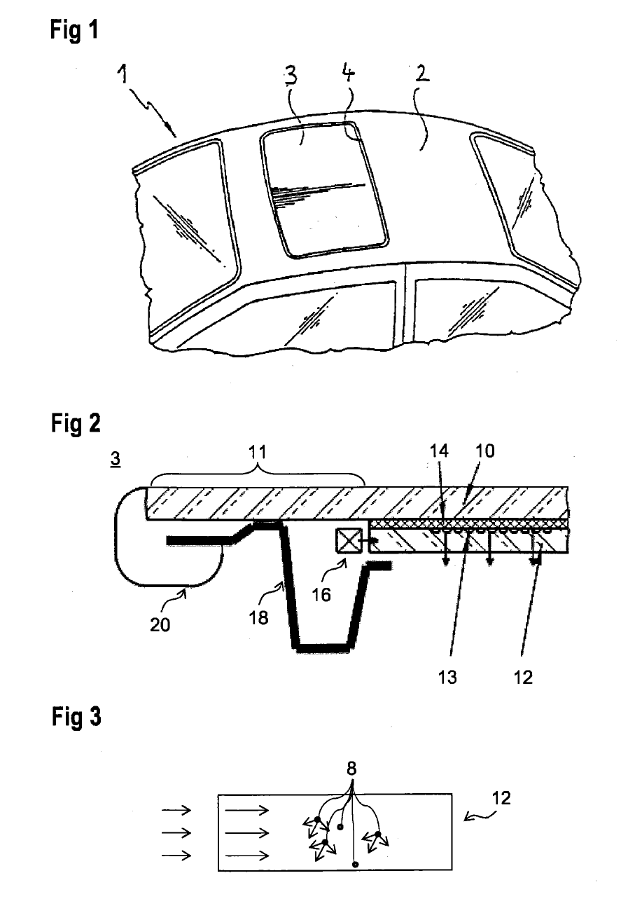

FIG. 2 shows an embodiment of an arrangement according to the invention,

FIG. 3 shows an embodiment of a light-conducting layer,

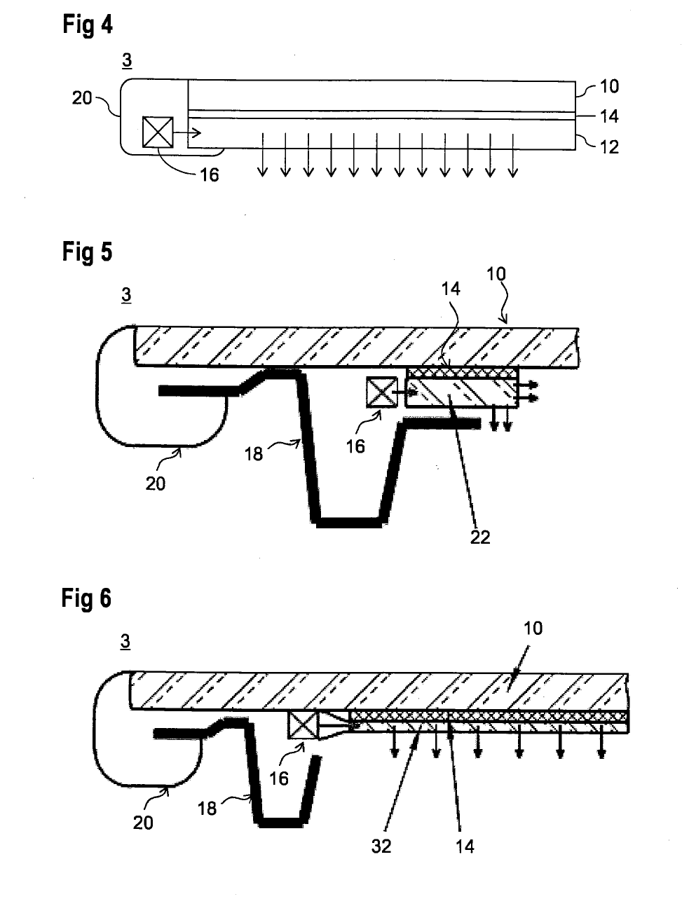

FIG. 4 shows a further embodiment of an arrangement according to the invention,

FIG. 5 shows a further embodiment of an arrangement according to the invention, and

FIG. 6 shows a further embodiment of an arrangement according to the invention.

FIG. 1 shows a passenger automobile 1, which a vehicle roof 2 having a roof part in the form of a cover 3, which is arranged in a roof opening 4. The cover 3 is implemented, for example, as a vehicle glazing.

FIG. 2 shows an embodiment of a vehicle glazing 3 having a pane 10, which is embodied, for example, as a tinted toughened glass, TG in short. A light-conducting layer 12 is attached below the pane 10, which is materially bonded via a bonding layer 14 to the pane 10. The material bond extends over the entire surface of the pane 10 with the exception of an edge region 11. In the vehicle glazing of FIG. 2, a light source 16 is additionally provided, which is arranged such that light is coupled in at an end side of the light-conducting layer 12. The light-conducting layer 12 is configured in particular in this case to conduct light coupled in at the end side in the longitudinal direction through the layer. Furthermore, the light-conducting layer 12 has structuring 13 of the surface, which acts as the decoupling means for the light, so that a light exit of laterally coupled-in light is preferably caused via the lower main surface. The structuring 13 is provided in this case in particular on the side of the layer 12 facing toward the pane 10.

The decoupling is based on the effect that light is refracted or scattered on the structuring 13 and is therefore emitted at an angle which enables an exit from the surface of the layer 12. Without the structuring, the coupled-in light is typically incident at such a flat angle on the surface of the layer 12 that total reflection of the light occurs.

The structuring 13 of the surface of the layer 12 is produced mechanically, for example, by imprinting the structure into the surface, for example. Alternatively, the structuring can be caused by printing, in particular using a pad print, so that the printed material represents the scattering structures. A further possibility for the structuring of the surface of the layer 12 consists of etching of the surface, by which the surface is roughened to generate the scattering effect. Furthermore, the roughening or structuring can also be achieved by a blasting method, for example, by sandblasting.

In this embodiment, a holding element 18 is provided in the edge region of the vehicle glazing 3, which is used, for example, as a fastening element of the glazing on the body or the roof 2 of the vehicle 1. A part of the holding element 18 is provided with a foam embedding 20, for example, which is embodied, for example, using a polyurethane (PU) foam. The light source 16 is enclosed by the holding element 18 in this embodiment, and therefore protected from external influences.

The bonding layer 14 can have multiple functions. On the one hand, it can be used as a lamination layer, which causes a permanent bond between the pane 10 and the layer 12. In addition, the layer 14 can be implemented as a refractive layer, which in particular has a lower index of refraction than the light-conducting layer. Light incident on the interface between the layer 12 and the layer 14 thus remains in the light-conducting layer 12 and does not pass into the pane 10. Light absorption in the pane 10 or light exit from the vehicle into the surroundings is avoided in this way.

Additionally, the layer 14 can exercise the function of a splinter protection layer or splinter protection film. For example, the layer 14 is implemented for this purpose from polyvinyl butyral, PVB in short.

The layer 14 is preferably provided so that it acts both as a lamination layer and also as a refractive layer, and furthermore simultaneously as a splinter protection film. Alternatively, the three functions can also be caused by a corresponding layer structure of multiple films.

FIG. 3 shows an alternative embodiment of the light-conducting layer 12, in which instead of a surface structuring, light-scattering particles 8 are embedded in the layer 12. In this case, the light-conducting layer 12 is preferably formed from a transparent plastic such as PMMA or PC. The light-scattering particles 8 essentially fulfill the same function as the surface structuring 13 and cause scattering of the light, so that emission of the conducted light into the vehicle interior is enabled. The light-scattering particles 8 are preferably not recognizable to the naked eye, so that without activated light source, the layer 12 still appears transparent.

In the embodiment of the light-conducting layer 12 in FIG. 2, the layer 12 is made of glass, in particular a toughened glass, TG, or a heat-strengthened glass, HSG. It is also possible that the layer 12 is formed from a transparent plastic. While the layer 12 acts as a rigid plate in the embodiment using glass, the layer 12 can be implemented both as a rigid plate and also as a flexible film in the embodiment using plastic.

FIG. 4 shows a further embodiment of a vehicle glazing 3, which is essentially based on the embodiment illustrated in FIG. 2. Notwithstanding this, the light-conducting layer 12 extends over the entire surface of the pane 10. In this case, a holding element 18 is not provided, while the light source 16, which is arranged on the end side of the layer 12, is enclosed by a foam embedding 20 together with the pane 10 and the layer 12. Both the surface structuring and also embedding of light-scattering particles can again be selected as the decoupling means.

FIG. 5 shows a further embodiment of a vehicle glazing 3, in which a light-conducting layer 22 is only attached in a partial region of the surface of the pane 10. Otherwise, this embodiment essentially corresponds to the embodiment of FIG. 2.

The layer 22 is implemented, for example, as an oblong strip or as a ring extending all around the pane 10. Therefore, surface illumination is not produced in this embodiment, but rather only illumination at the edge of the pane 10. Light decoupling from the layer 22, which is illustrated by corresponding arrows, is performed by the corresponding decoupling means both essentially perpendicular to the surface of the pane 10 or the layer 22 and also at an end side of the layer 22 opposite to the light source 16.

FIG. 6 shows a further embodiment of a vehicle glazing 3, which is again based on the embodiment illustrated in FIG. 2. In this embodiment, instead of the layer 12 embodied as a rigid plate, a layer 32 embodied as a flexible film is provided, which is again bonded via the layer 14 to the pane 10. Light decoupling from the layer 32 is preferably produced via embedded light-scattering particles, as illustrated in the embodiment of FIG. 3. The use of a film makes simplified processing possible and provides a saving in weight.

In all above-described embodiments of the vehicle glazing 3, a scratch-resistant coating can be applied below the light-conducting layer, i.e. on the side of the light-conducting layer facing away from the pane 10. Furthermore, in the illustrated embodiments of the vehicle glazing 3, the light source 16 is attached directly to the light-conducting layer in each case. Notwithstanding this, the light source can also be provided at another position and light conduction at the end face of the light-conducting layer can be supplied via corresponding optical waveguides.

Alterations and combinations of the described embodiments are, of course, possible and included by the invention.

1-11. (canceled)

12. A vehicle glazing, comprising:
a pane;
a light-conducting layer, which is configured to conduct light coupled in at one of its end sides, which is materially bonded to the pane, and which has decoupling means, via which a light exit of conducted light is caused on at least one of the light-conducting layer's main surfaces;
a refractive layer, which is arranged between the pane and the light-conducting layer, which has a lower index of refraction than the light-conducting layer, and which is simultaneously implemented as a lamination layer; and
a light source, which is arranged such that light is coupled in at least one end side of the light-conducting layer.

13. The vehicle glazing of claim 12, wherein the material bond is formed by the lamination layer.

14. The vehicle glazing of claim 12, wherein the light-conducting layer extends over the entire surface of the pane.

15. The vehicle glazing of claim 12, wherein the light-conducting layer is attached in at least one of a partial region of the surface of the pane.

16. The vehicle glazing of claim 12, wherein the light-conducting layer is formed from glass.

17. The vehicle glazing of claim 12, wherein the light-conducting layer is formed from a transparent plastic.

18. The vehicle glazing of claim 17, wherein the decoupling means are formed by light-scattering particles embedded in the plastic.

19. The vehicle glazing of claim 12, wherein the decoupling means are formed by structuring of a surface of the light-conducting layer.

20. The vehicle glazing of claim 19, wherein the structuring of the surface is formed by at least one of mechanical structuring; printing; etching; and blasting.

21. The vehicle glazing of claim 12, wherein the light-conducting layer is implemented as a rigid plate.

22. The vehicle glazing of claim 17, wherein the light-conducting layer is implemented as a flexible film.

23. The vehicle glazing of claim 12, wherein the pane is made of a glass selected from the group consisting of toughened glass; toughened safety glass; and tempered safety glass.

24. The vehicle glazing of claim 16, wherein the glass of the light-conducting layer is selected from the group consisting of toughened glass, toughened safety glass and heat-strengthened glass.

25. The vehicle glazing of claim 17, wherein the transparent plastic of the light-conducting layer is selected from the group consisting of polymethyl methacrylate, polyarbonate.

26. The vehicle glazing of claim 12, wherein the light-conducting layer extends over the entire surface of the pane with the exception of an edge region.
